(19) United States
(12) Patent Application Publication
(10) Pub. No.: US 2023/0250249 A1
(43) Pub. Date: Aug. 10, 2023

(54) Porous Silicone Rubber with Closed-Cell Porosity

(71) Applicant: Cilag GMBH International, Zug (CH)

(72) Inventor: Duan Li Ou, Warren, NJ (US)

(21) Appl. No.: 17/667,969

(22) Filed: Feb. 9, 2022

(51) Int. Cl. C08J 9/00; C08G 77/08; C08G 77/12; C08G 77/20; C08K 3/36; C08J 3/00; C08J 3/24; C08J 9/02

(52) U.S. Cl. CPC C08J 9/0061; C08G 77/08; C08G 77/12; C08G 77/20; C08K 3/36; C08J 3/005; C08J 3/24; C08J 9/0066; C08J 9/02; C08J 2205/052; C08J 2383/05; C08J 2383/07; C08J 2207/10; C08G 2101/00

(57) ABSTRACT

Novel methods for producing porous silicone compositions are disclosed. Methods of this invention provide improved processes for preparing porous silicone rubbers having low specific gravity and mainly closed cells which are suitable for highly permeable gas penetration while adequately sealing liquid material. Examples of these sealing materials include but are not limited to encapsulants for bioindicators and syringe sealing components wherein the permeability is sufficient to permit sterilization while preventing passage or leaking of liquids to be sterilized through the described silicone materials.

### CROSS-REFERENCE TO RELATED APPLICATION(S)

This application is related to U.S. Non-Provisional Application No. (Attorney Docket No. ETH6121USNP1) concurrently filed herewith and having a common assignee the contents of which are herein incorporated by reference in their entirety for all purposes.

### TECHNICAL FIELD

The field of art to which this invention pertains is silicone-based, closed celled materials that can adequately prevent passage of liquids while permitting sufficient permeability to enable sterilization of the liquids such as by ethylene oxide sterilization or indicate presence of a contaminate when the materials are used in conjunction with biological indicators.

### BACKGROUND OF THE INVENTION

An in-situ hydrogen generation reaction involving phase separation has conventionally been known as a method for obtaining a monolithic porous material with controlled pore sizes in an organic-inorganic hybrid system using an oxide such as silica, and a SiH function containing silesquixane resin were used as starting materials (Microporous and Mesoporous Materials 57 (2), 133-142, 2003). However, in those porous bodies, elastic modulus of a gel is extremely high, and brittleness is high as a whole. Therefore, it was difficult to impart flexibility withstanding large deformation to the porous bodies.

It is an object of this invention to provide an improved process and improved compositions for preparing porous silicone rubbers having low specific gravity and mainly closed cells which are suitable to permit passage of gases, such as ethylene oxide sterilants, while inhibiting passage of the liquid being sterilized. Such compositions are well suited as sealing materials. Examples of these sealing materials include but are not limited to an encapsulant for bioindicators and syringe sealing components.

### SUMMARY OF THE INVENTION

One aspect of this invention is related to the creation of various levels of porosity (1 to 80%) for various sealing components for syringes. At such levels, permeability of sterilant gas is achievable while maintaining adequate protection against leakage of liquid contents in a syringe.

Therefore, one embodiment of this invention is related to a method of making a porous silicone composition comprising the steps of:

a) cooling a Part A composition comprising a mixture of:

60 to 95 wt. % vinyl terminated polydimethyl silicone base polymer and fumed silica particles,

5 to 15 wt. % vinyl terminated polydimethylsiloxane having a molecular weight ranging from 3,000 to 9,000, and

a platinum containing catalyst; and

b) cooling a Part B composition comprising a mixture of:

60 to 90 wt. % vinyl terminated polydimethyl silicone base polymer and fumed silica particles, and

10 to 40 wt. % polymethylhydro-co-polydimethyl siloxane cross linker; and

c) mixing the Part A and Part B compositions to form a combined composition and permitting the combined composition to form a cured porous silicone composition;

wherein the platinum containing catalyst comprises at least 1 ppm of elemental platinum in said combined composition.

In preferred embodiments the cooling of Parts A and B are to a temperature below +5 C, preferably between −20 and −60 C, and most preferably at −25 C.

In other preferred embodiments the amount of elemental Pt present in the compositions range from 1-150 ppm Pt, more preferably 5-30 ppm Pt.

Accordingly, the present invention is able to provide a porous body (monolith) having high flexibility and elasticity on a different type of silicone based polymer, with porosity ranges from 1 to 80% of the total volume of the solid.

Another aspect of this invention is related to the creation of silicone compositions with low porosity levels at ambient conditions to encapsulate biological indicators (BI). Such porosities are in the range of 1 to 4% volume percent porosity

Accordingly, catalytic compositions , silicone based bondable porous silicone film compositions are disclosed, such porous film compositions bond to a variety of substrate materials, such as paper, stainless steel, polyester film, etc. Especially useful substrates are biological indicators.

In one embodiment such film compositions comprise a porous coating formed by curing a liquid composition comprising:

a cross-linkable silicone polymer having reactive functionalities;

a silica-containing composition;

a silicone cross-linking agent; and

a catalyst, wherein said catalyst comprises at least two catalysts,

a first catalyst comprising a Karstedt's catalyst comprising Platinum-divinyl-tetramethyldisiloxane complex, and

a second catalyst comprising platinum tetramethyldivinyl disiloxane diethyl maleate complex having the formula:

Pt[(CH₂═CH)(CH₃)₂Si]₂O.(COCH═CHCO)(C₂H₅O)₂ (i)

or

Pt[(CH₂═CH)(CH₃)₂Si]₂O (ii)

or mixtures thereof of catalysts (i) and (ii), wherein the platinum containing catalyst comprises at least 1 ppm of elemental platinum in the composition.

Preferably the resulting film compositions have elemental Pt in the range of 1-150 ppm more preferably in the range of 5-30 ppm Pt.

These porous coating/films of this invention are permeable by ethylene oxide gas and impermeable by a cross-linkable silicone liquids and may be applied to such substrates as a biological indicator.

The invention also contemplates products made by the disclosed methods of this invention as well as devices such as biological indicators coated with the disclosed compositions of this invention.

In the foregoing embodiments, the silica-containing composition may be added as a separate component, but more preferably it is contained in the cross-linkable silicone polymer. The silicone foam compositions may also contain a platinum catalyst.

### BRIEF DESCRIPTION OF THE DRAWINGS

The patent or application file contains at least one drawing executed in color. Copies of this patent with color drawings will be provided by the Patent and Trademark Office upon request and payment of necessary fee.

FIG. 1 is a picture of a porous silicone rubber monolith produced by one of the methods of this invention.

FIG. 2 is a depiction of components of a dual barrel syringe including a porous cap seal (septa) made according to the methods of this invention.

FIG. 3 depicts leakage integrity of seals made according to the methods of this invention.

FIG. 4 is a picture of a biological indicator (BI) encapsulated by a porous silicone film of this invention.

### DETAILED DESCRIPTION OF THE INVENTION

One embodiment of this invention provides an improved process for preparing porous silicone rubbers having low specific gravity and mainly closed cells which are suitable for passage of gases while resisting or stopping passage of liquids.

Another embodiment relates to composition made from the hereinafter disclosed process for preparing porous silicone rubbers.

The compositions of this invention include a mixtures of cross linkable polydimethylsiloxane and polydimethylhydrosiloxane containing cross linker, and a conventional platinum catalyst, and surface treated silica filler.

The terms silicone and siloxane are conventionally used interchangeably in this art, and that usage has been adopted herein.

In one embodiment, the compositions include a mixture of a cross-linkable siloxane polymer and a silica-containing composition which may be added as a separate component, but more preferably contained in the cross-linkable silicone polymer, a conventional silicone cross-linking agent, and a platinum catalyst. The silicone polymer components are blended with conventional aromatic organic solvents, including, for example, aliphatic organic solvents (such as, for example, hexane, heptane or its commercial derivatives) to form coating solutions or compositions. Other solvent suitable for coating solution includes and not limited to low molecular weight siloxane, e.g., hexamethyldisiloxane.

The cross-linkable siloxane polymers useful in the compositions of the present invention will have reactive functionalities or terminal functional groups, including but not limited to vinyl terminated, hydroxyl and acrylate functional groups. The cross-linkable siloxane polymers that can be used in the compositions of the present invention preferably include vinyl terminated polydialkylsiloxane or vinyl terminated polyalkyarylsiloxane. Examples include but are not limited to the following vinyl terminated siloxane polymers: polydimethyl siloxane, polydiphenylsilane-dimethylsiloxane copolymer, polyphenylmethylsiloxane, polyfluoropropylmethyl-dimethylsiloxane copolymer and polydiethylsiloxane. It is particularly preferred to use vinyl terminated cross-linkable polymethyl siloxane.

The cross-linking agents that can be used in the compositions of the present invention include conventional silicone cross-linking agents such as, for example, polymethylhydro siloxane, polymethylhydro-co-polydimethylsiloxane, polyethyhydrosiloxane, polymethylhydrosiloxane-co-octylmethylsiloxane, polymethylhydrosiloxane-co-methylphenylsiloxane. The preferred conventional crosslinkers for use in the compositions of the present invention are polymethylhydro siloxane and polymethylhydro-co-polydimethylsiloxane. Precise control of cross-link density in the coatings of the present invention is achieved by precise control of the ratio of non-cross-linkable silicone polymer (e.g., polydimethylsiloxane) to fully cross-linked polymer. The fully cross-linked polymer is formed by a reaction between the functionalized cross-linkable polymer and the cross-linking agent, for example, a vinylsilylation reaction between vinyl-terminated polydimethylsiloxane and polymethylhydrosiloxane optionally in the presence of a platinum complex catalyst. Examples of this polymer include but are not limited to: Gelest Product Code No. DMS-V31, DMS-V33, DMS V-35, DMS V42, DMS-V46, DMS-V52, etc., available from Gelest, Inc., Morrisville, Pa. 19067. The typical molecular structure of vinyl terminated polydimethyldisiloxane is the following:

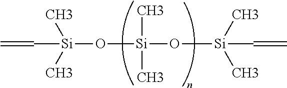

wherein n is defined by the molecular weight.

The molecular weights of the silicone polymers used wherein can be estimated based on the relationship between viscosity and molecular weight (page 11, SILICONE FLUIDS: STABLE, INERT MEDIA ENGINEERING AND DESIGN PROPERTIES, Catalog published by Gelest, Inc. 11 East Steel Rd. Morrisville, Pa. 19067). Using A. J. Barry's relationship for molecular weights (M)>2,500 correlating the kinematic viscosity μ expressed in centistokes (cSt) at 25 C, the molecular weight M of silicones can be estimated as follows:

logμ_{cSt}=1.00+0.0123M^{0.5}

(as published by A. J. Barry in the Journal of Applied Physics 17, 1020 (1946))

Vinyl terminated polydimethylsiloxane reacts with polymethylhydrosiloxane cross-linker in the presence of platinum catalyst under appropriate conditions; the vinyl terminated polydimethylsiloxane linear polymers are fully cross-linked to each other as the result of this reaction. The amount of polymethylhydrosiloxane cross-linker is in large stoichiometric excess compared to vinyl terminated polydimethylsiloxane base polymer. It is believed that the extra SiH functions in the cross-linker react with the OH functions on the surface such as human skin, e.g., polymeric sutures, to form Si—O—C bonds at elevated temperature or in the case of steel needles, to form Si—O—Fe bonds. Covalent bonds thus created between the silicone coating and the device, as the result of this reaction, result in the adhesive attachment of the coating to a given surface.

The polymethyhydrosiloxane cross-linkers, or cross-linking agents, used in the practice of the present invention will have a molecular weight between about 1000 and about 3000, and preferably between about 1400 and about 2100. An example of this polymer cross-linker includes, but is not limited to, Gelest Product Code No. HMS-991, HMS-992, available from Gelest, Inc., Morrisville, Pa. 19607. The typical molecular structure of the polymethylhydrosiloxane cross-linker is the following:

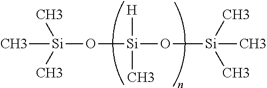

wherein n is defined by the molecular weight.

Polymethylhydro-co-polydimethylsiloxane can also be used as cross-linker or cross-linking 5 agent in the novel coatings of the present invention. Examples of this polymer include, but are not limited to, Gelest Product Code No. HMS-301, HMS-501. The molecular weight of this siloxane polymer cross-linking agent will typically be between about 900 and about 5,000, and preferably about 1,200 to about 3,000. The typical molecular structure of polymethylhydro-co-polydimethylsiloxane cross linker is the following:

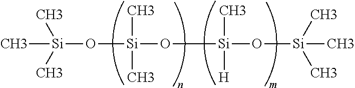

wherein n and m are defined by the molecular weight.

Silica-Containing Compositions

As used herein, the silica-containing compositions described for use with this invention 15 include silica materials as a separate component (such as surface treated silica) or from commercially available compositions that contain silica in a cross linkable silicone polymer mixture. Silica filler is used as a reinforcement component to enhance the mechanical properties of cross linked polydimethyl siloxane substrate materials.

As a separate component, silica is incorporated into composition of this invention to act as a bonding agent to skin and other substrate materials. It is believed that the OH groups on the surface of silica particles react with the OH functions on the surface of substrate material including human skin under a certain condition, as illustrated below.

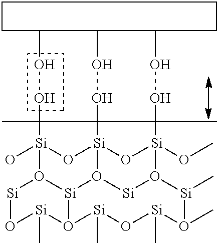

Silica particles were incorporated into the cross linkable silicone polymers. Hexamethyl silyl surface treatment is needed for the silica particles to enable its compatibility to the polysiloxane polymer matrix which prevents phase separation. An example of treated silica includes hexamethyldisilazane treated silica i.e., trimethyl silyl surface treated silica filler (Gelest SIS6962.0).

In the case of silicone polymers already containing silica, these may be obtained from commercially available sources such as silica-containing composition selected from reactive silica-containing silicone bases including HCR (high consistent rubber) bases and LSR (liquid silicone rubber) bases, preferred are LSR bases. Other commercial examples of this material include and is not limited to Wacker 401-10, 401-20, 401-40 base; and a liquid silicone rubber base, a commercial example of this material includes and is not limited to Bluestar Silbione LSR 4370 base. These type of commercial silicone rubber bases are prepared by mixing a surface-treated silica filler with various molecular weights of vinyl terminated polydimethylsiloxane polymer. In-situ surface treatment may be performed during the mixing process to improve the compatibility between filler and polysiloxane polymer.

Catalyst Karstedt of GE Silicone invented a highly active platinum catalyst at the beginning of the 1970's (U.S. Pat. No. 3,775,452). Vinyl terminated polydimethylsiloxane can react with polymethylhydrosiloxane containing cross linker in less than 1 minute at ambient temperature with as little as 10 ppm of the Karstedt catalyst. This catalyst is suitable and was used for the preparation of porous silicone foam monoliths.

For forming porous silicone, coatings, films and encapsulants, traditional Karstedt platinum catalyst does not enable the reaction between OH groups on the surface of silica particles to react with the OH functions on the surface of substrate, which enables a silicone film to bond to a given substrate. This type of condensation reaction tends to be slow at ambient condition and the typical catalyst for this reaction including organic amine and catalyst such as tin dilaurate. Trace amount of condensation catalyst will terminate the catalytic ability of platinum catalyst which is referred as platinum poisoning in the silicone industry. A platinum catalyst is needed to activate the OH condensation between silica particle and substrate material, to enable rapid adhesion formation between silicone and a given substrate material. A platinum based catalyst of the present invention is able to activate both vinyl silylation and OH condensation simultaneously.

The catalyst is prepared by reacting Karstedt's catalyst with diethyl maleate according to scheme 1. The platinum tetramethyldivinyl disiloxane diethyl maleate catalyst enables both vinyl silylation and condensation reaction. This is referred to as “dual functional silicone catalyst”.

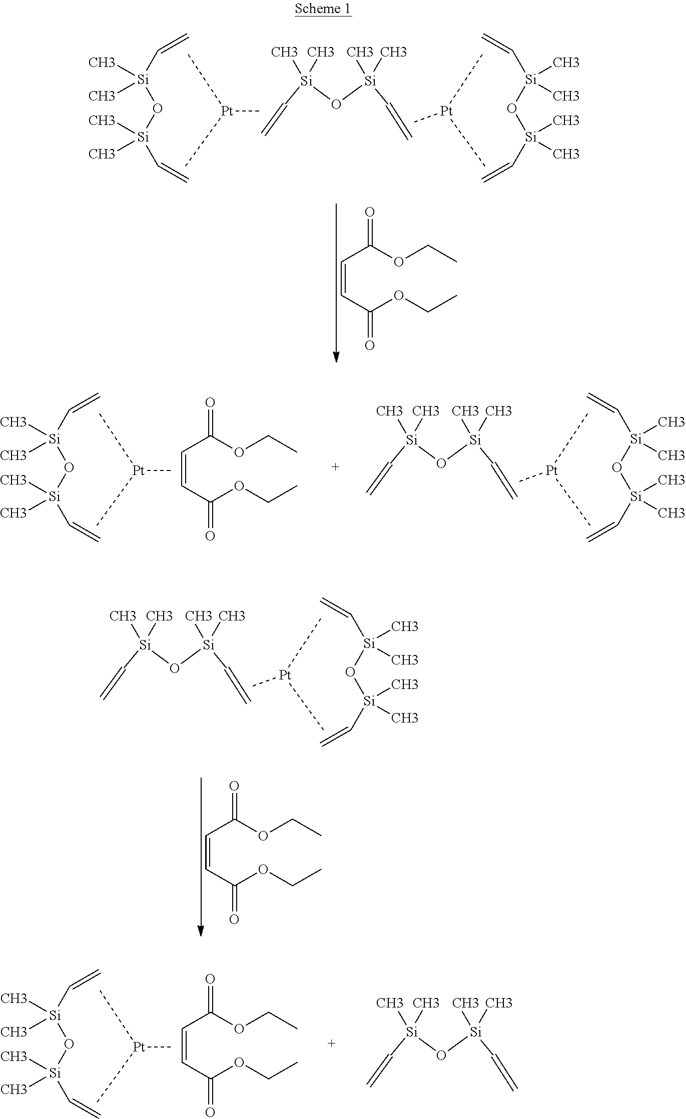

The catalyst used to form the silicone films used in the present invention is disclosed in commonly assigned, co-pending patent application, U.S. Ser. No. 17/327,940 (ETH6070USCIP1), the entirely of the disclosure of which is herein incorporated by reference and is prepared in the following manner. Karstedt catalyst in xylene solution is mixed with a low concentration of vinylcyclohexanol in a xylene solution at ambient temperature for a sufficiently effective time to complete the reaction, e.g., a half an hour, and completion of the reaction is indicated by a change of the color of the reaction mixture, from clear to light brown.

The resulting catalyst is ready to use in a composition useful as a an encapsulant film. The formula of the resulting platinum complex catalyst (platinum tetramethyldivinyl disiloxane diethyl maleate complex) is:

Pt[(CH₂═CH)(CH₃)₂Si]₂O.(COCH═CHCO)(C₂H₅O)₂ (i)

or may be used in the non-complexed form as

Pt[(CH₂═CH)(CH₃)₂Si]₂O (ii)

or as mixtures of both (i) and (ii).

The forgoing catalysts were used alongside the conventional Karstedt catalyst for the preparation of porous silicone foam coatings. It has been surprisingly found that when using a Karstedt catalyst in combination with catalyst (i), catalyst (ii) or mixtures thereof, the elemental Pt loading can be reduced. Specifically, it has been found that higher concentrations of elemental Pt were observed to leach out of the formulation over time. For example, a loading of 80 ppm Pt of catalyst (i), (ii), or their mixtures can be reduced to under 20 ppm Pt (total) when used in combination with a Karstedt catalyst while still have the desired properties as an encapsulant film.

It should be noted that the resulting catalyst reaction mixture may contain a small amount of the reaction product divinyltetramethyldisiloxane. This component does not affect the catalyst and is a low boiling point component that is rapidly evaporated. Accordingly, purification of the catalyst mixture to remove divinyltetramethyldisiloxane is optional, and it is believed that its presence at ultra low concentrations will not affect the cross-linking reaction of a cross-linkable silicone polymer. The novel catalyst of the present invention also actives the bonding formation between silanol groups on the surface of silica fillers and OH functions on a given surface, that is, the catalyst is capable to activate two reactions. This allows for curing the cross-linkable components in silicone coatings to rapidly form coating films at desired curing temperatures and provides bonding to a given substrate such as human skin.

Process for Closed Cell Silicone Foam Formation

The OH groups on the surface of silica particles will react with excess amounts of SiH functionality on the cross linker under certain conditions, such as in the presence of a platinum catalyst during cross linking process according to the following reaction:

SiH+Si—OH→Si—O—Si+H2

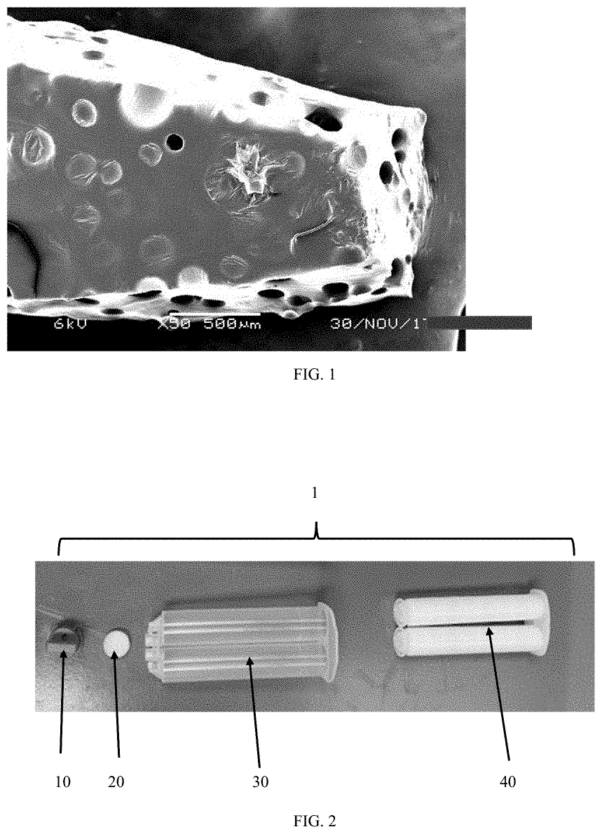

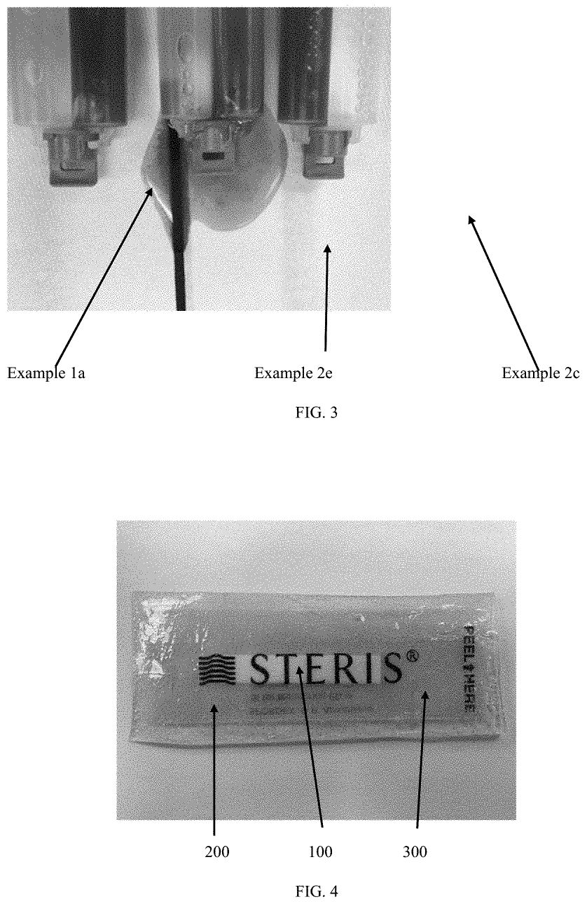

To enable the above reaction to occur, excess amount of polymethyhydrosiloxane cross linker is added to the reaction mixture, gas bubbles form during the cross linking process as the result of the above reaction. For EO permeable sealing components, conventional RTV-2 was used as the matrix material and up to 5 weight percent of extra polymethyhydrosiloxane cross linker was added. Examples of RTV includes but are not limited to Elkem Silbione RTV4410. An image of the resulting porous silicone rubber monolith (see further preparation details are in Example 1b below) is shown in FIG. 1.

Commercial RTV (Room Temperature Vulcanizing) Foams

Soft silicone RTV foam is commercially available in the form of high porosity silicone rubber, commercial examples of this material include and not limited to Elkem Silbione RTV foam. While these foams are useful as a component used with this invention, they alone are insufficient to produce the desired closed cell porosity of this invention as hereinafter described.

The kind of commercial silicone RTV foam was prepared by mixing silica filler with vinyl terminated polydimethylsiloxane polymer. Foaming agents are also added during the mixing process for porosity creation. Polymethyhydrosiloxane cross linker and platinum catalyst was added into the above mixture independently to form two separate parts for easy storage. Often referred to as Part A and Part B compositions. As described in the above section the cross linker is one of the foaming agents used in these types of products, among others.

RTV foam gives very high percentage of porosity which makes it inferior for sealing properties, given amount of RTV foam raw material was mixed with conventional RTV foam such as Elkem Sibione 4410 to control the level of porosity of the resulting silicone foam, to provide desire permeation and sealing properties for the objective applications.

For the application in porous silicone encapsulant, in which rapid curing is required which needs custom catalyst package, a Elkem lower viscosity LSR base (Experimental base 55) was used as the matrix material, the encapsulant required good thickness uniformity and fully cured within 1 minute to minimize the bleach of uncrosslinked components into the packaging of conventional biologic indicators.

Porous Silicone Monolith Preparation

Low durometer RTV-2 is the preferred choice for porous silicone rubber due to its easy fabrication in laboratory settings. Both LSR and HCR material can also be used as the matrix material for porous silicone rubber.

A selected grade of the two-part RTV was mixed together (Examples 1 and 2) with excess amount of cross linker using a static mixer and the mixture was poured into a mold to form a part with a desired geometry, for the ease of volumetric measurement, cylindrical parts were molded. Color was added as an option. It would be appreciated by one of skill in the art that any suitable type of mold may be used to form desired shapes whether the shapes be those of cones, cylinders, cuboids, cubes, spheres, prisms, pyramids or any other desired types of 3-dimensional shapes.

The proposed silicone foam monolith can be dried or cured at ambient temperature in less than 4 hours and in some embodiments in one hour. The components of the silicone foams formulation were refrigerated at most preferably at −25 C prior to its mixing and cast into any desired shape immediately after its mixing. In other embodiments the cooling of Parts A and B are below +5 C, preferably between −20 and −60 C, and again most preferably at −25 C. The inventor has found that mixing the two-part compositions at a temperature at +5 C and above was not feasible as at these temperatures the combined two-part composition was not able to be cast into a mold due to poor flow properties.

Porous Silicone Rubber Coating/Film Preparation

The two-part low porosity silicone sealant compositions were mixed (Examples 3) using a conventional dual barrel syringe equipped with a static mixer and applied onto the surface of biologic indicator (BI). In order to cover the entire surface of a 2 mm wide BI strip, a conventional draw down bar was used for the coating process. The same process was repeated on the other side of the BI strip after 1 hour. The entire BI strip is encapsulated by the porous silicone sealant. A uniform 1 mm porous silicone film was also made on a Teflon substrate, using the same approach. An 20×20 mm coupon of the free-standing film was cut for density and porosity measurement.

The proposed silicone foam film coatings can be cured at ambient temperature in less than 5 minutes. The components of the silicone foam coating formulations were mixed at ambient temperature and coated onto a given substrate immediately after its mixing.

The bonding formation between the silicone foam coating and a given substrate is enabled by the condensation reaction between the silanol functions on the surface of silica particles and the OH functions on the substrate. Silanol condensation tends to be sluggish at ambient temperature and the non-conventional catalyst enables this reaction to occur in a short period of time. The platinum based catalyst also activates vinyl silylation reaction to allow vinyl terminated silicone polymer to cross link simultaneously to the condensation reaction.

Solvent Free Embodiments

In some embodiments, use of organic solvent free mixing compositions are more desirable. Such embodiments include situations where contents of a mixing device, such as a dual-barrel syringe, may be made with a solvent in which contents of the syringe leak past seals of the syringe or the solvent evaporates. We have found that suitable compositions are possible without use of organic solvents by substituting a low molecular weight (3000 to 9000) vinyl terminated polydimethylsiloxane and/or low molecular wight (3000 to 9000) hydride terminated polydimethylsiloxane. Both these types of low molecular vinyl terminated or hydride terminated polydimethylsiloxane compounds have viscosities in the 40-150 cPs range. We have demonstrated that these solvent free formulations are capable of lowering viscosity of high viscosity silicone bases that that have viscosities typically higher than 500,000 and up to several million centipoise.

In these embodiments, the Part A compositions will typically comprise a silicone base (containing vinyl terminated polydimethylsiloxane base polymer and fumed silica particles) ranging from 60 to 95 wt. % when controlling to a Part A viscosity of 45,000 to 75,000 cPs (or 30 to 100 wt. % when controlling to a Part A viscosity of 15,000-45,000 cPs, or 0 to 40 wt. % when controlling to a Part A viscosity of a 75,000 to 105,000 cPs); 5 to 15 wt. % 50 to 300 cPs vinyl terminated polydimethylsiloxane; and Pt catalyst.

When making porous silicone monoliths, the Karstedt catalyst providing elemental Pt of at least 1 ppm Pt, preferably 1-150 ppm Pt and most preferably 5-30 ppm Pt were found to be effective in this invention.

When making porous encapsulating films, it was found that a combination of catalysts were required. Specially required was the combination of

Pt[(CH₂═CH)(CH₃)₂Si]₂O.(COCH═CHCO)(C₂H₅O)₂ (i)

or

Pt[(CH₂═CH)(CH₃)₂Si]₂O (ii)

or mixtures of catalysts (i) and (ii)

in conjunction with a Karstedt catalyst to provide elemental Pt of at least 1 ppm Pt, preferably 1-150 ppm Pt and most preferably 5-30 ppm Pt were found to be effective in this invention.

Part B compositions will typically comprise a silicone base (containing vinyl terminated polydimethylsiloxane base polymer and fumed silica particles) ranging from 60 to 80 wt. % when controlling to a Part B viscosity of 45,000 to 75,000 cPs base, (or 0 to 30 wt. % when controlling to a Part B viscosity of 15,000-45,000 cPs base, or 70 to 100 wt. % when controlling to a Part B viscosity of 75,000 to 105,000 cPs base); and 10 to 40 wt. % polymethylhydro-co-polydimethylsiloxane cross linker.

Typically, the viscosity of both the Part A and Part B compositions will independently range between 25,000 and 100,000 cPs prior to mixing and will be of similar viscosity when Part A and Part B are used in conjunction with each other around a low, medium or high viscosity level.

### EXAMPLES

### Example 1a, Preparation of Porous Silicone Foam using in situ Foam Generator (Lowest Percent Porosity)

Part A:

20 g of ElKem Silbione RTV4410A (consisting of vinyl terminated polydimethylsiloxane, silica filler and Karstedt platinum catalyst) was mixed with 0.2 g of 1% Gelest SIP6830.3 platinum catalyst (Karstedt catalyst) in vinyl terminated polydimethyl siloxane (Gelest DMS V21) at ambient temperature using a high speed centrifugal mixer (FlackTek DAC150 FV-K) at 3470 rpm for 1 min, then stored at −25 C prior to its mixing with Part B.

Part B.

20 g of ElKem Silbione RTV4410B (consisting of vinyl terminated polydimethylsiloxane, polymethylhydrosiloxane containing cross linker and silica filler) and 2 g of polymethylhydro-co-polydimethylsiloxane Gelest HMS301 were mixed at ambient temperature using a high speed centrifugal mixer (FlackTek DAC150 FV-K) at 3470 rpm for 1 min at ambient temperature, stored at −25 C prior to its mixing with Part A.

Porous Foam Monolith Formation

The pre-refrigerated Part A was mixed with pre-refrigerated Part B at ambient temperature using a high speed centrifugal mixer (FlackTek DAC150 FV-K) at 3470 rpm for 1 min, and cast into a mold to form a monolith with desired geometry immediately after its mixing. The mixture dried and was demolded after approximately 4 hours. The resulting composition was calculated to contain approximately 5 to 30 ppm of elemental platinum.

### Example 1b, Preparation of Porous Silicone Foam using In Situ Foam Generator (Lower Percent Porosity)

Part A:

20 g of ElKem Silbione RTV4410A (consisting of vinyl terminated polydimethylsiloxane, silica filler and Karstedt platinum catalyst) was mixed with 0.2 g of 1% Gelest SIP6830.3 platinum catalyst (Karstedt catalyst) in vinyl terminated polydimethyl siloxane (Gelest DMS V21) at ambient temperature using a high speed centrifugal mixer (FlackTek DAC150 FV-K) at 3470 rpm for 1 min, stored at −25 C prior to its mixing with Part B.

Part B.

20 g of ElKem Silbione RTV4410B(consisting of vinyl terminated polydimethylsiloxane, polymethylhydrosiloxane containing cross linker and silica filler) and 2 g of polymethylhydrosiloxane Gelest HMS991 were mixed at ambient temperature using a high speed centrifugal mixer (FlackTek DAC150 FV-K) at 3470 rpm for 1 min then stored at −25 C prior to its mixing with Part A.

Porous Foam Monolith Formation

The pre-refrigerated Part A was mixed with pre-refrigerated Part B at ambient temperature using a high speed centrifugal mixer (FlackTek DAC150 FV-K) at 3470 rpm for 1 min, and cast into a mold to form a monolith with desired geometry immediately after its mixing. The mixture dried and was demolded after approximately 4 hours, The resulting composition was calculated to contain approximately 5 to 30 ppm of elemental platinum.

### Example 1c, Preparation of Porous Silicone Foam using In Situ Foam Generator (Lower Percent Porosity)

Part A:

16 g of ElKem Silbione RTV4410A (consisting of vinyl terminated polydimethylsiloxane, silica filler and Karstedt platinum catalyst) was mixed with 0.2 g of 1% Gelest SIP6830.3 platinum catalyst (Karstedt catalyst) in vinyl terminated polydimethyl siloxane (Gelest DMS V21) at ambient temperature using a high speed centrifugal mixer (FlackTek DAC150 FV-K) at 3470 rpm for 1 min, stored at −25 C prior to its mixing with Part B.

Part B:

16 g of ElKem Silbione RTV4410B (consisting of vinyl terminated polydimethylsiloxane, polymethylhydrosiloxane containing cross linker and silica filler) and 4 g of polymethylhydrosiloxane Gelest HMS991 were mixed at ambient temperature using a high speed centrifugal mixer (FlackTek DAC150 FV-K) at 3470 rpm for 1 min then stored at −25 C prior to its mixing with Part A.

Porous Foam Monolith Formation

The pre-refrigerated Part A was mixed with pre refrigerated Part B at ambient temperature using a high speed centrifugal mixer (FlackTek DAC150 FV-K) at 3470 rpm for 1 min, and cast into a mold to form a monolith with a desired geometry immediately after its mixing. The mixture dried and was demolded after approximately 4 hours. The resulting composition was calculated to contain approximately 5 to 30 ppm of elemental platinum.

### Example 2a. Mixture using Commercial Porous Foam

Part A:

10 g of Silbione RT foam 4230A was mixed with 90 g of ElKem Silbione RTV4410A (consisting of vinyl terminated polydimethylsiloxane, silica filler and Karstedt platinum catalyst) using a high speed centrifugal mixer (FlackTek DAC150 FV-K) at 3470 rpm for 1 min to form the Part A mixture.

Part B:

10 g of Silbione RT foam 4230B was mixed with 90 g of ElKem Silbione RTV4410B (consisting of vinyl terminated polydimethylsiloxane, polymethylhydrosiloxane containing cross linker and silica filler) using a high speed centrifugal mixer (FlackTek DAC150 FV-K) at 3470 rpm for 1 min to form the Part B mixture.

Porous Foam Monolith Formation

Both the Part A and Part B mixtures were separately stored at −25 C prior to their final mixing. Part A and Part B were mixed by hand for 30 seconds prior to its casting into a mold to form its desired shape. The porous silicone monolith fully cured after 1 hour. The resulting composition was calculated to contain approximately 5 to 30 ppm of elemental platinum.

### Example 2b. Mixture using Commercial Porous Foam

Part A:

30 g of Silbione RT foam 4230A was mixed with 70 g of ElKem Silbione RTV4410A using a high speed centrifugal mixer (FlackTek DAC150 FV-K) at 3470 rpm for 1 min to form the Part A mixture.

Part B:

30 g of Silbione RT foam 4230B was mixed with 70 g of ElKem Silbione RTV4410B using a high speed centrifugal mixer (FlackTek DAC150 FV-K) at 3470 rpm for 1 min to form the Part B mixture.

Porous Foam Monolith Formation

Both the Part A and Part B mixtures were separately stored at −25 C prior to their final mixing. Part A and Part B were mixed by hand for 30 seconds prior to its casting into a mold to form its desire shape. The porous silicone monolith fully cured after 1 hour. The resulting composition was calculated to contain approximately 5 to 30 ppm of elemental platinum.

Example 2c. Mixture using Commercial Porous Foam 50 g of Silbione RT foam 4230A was mixed with 50 g of ElKem Silbione RTV4410A using a high speed centrifugal mixer (FlackTek DAC150 FV-K) at 3470 rpm for 1 min to form the Part A mixture.

50 g of Silbione RT foam 4230B was mixed with 50g of ElKem Silbione RTV4410B using a high speed centrifugal mixer (FlackTek DAC150 FV-K) at 3470 rpm for 1 min to form the Part B mixture.

Both the Part A and Part B mixtures were separately stored at −25 C prior to their final mixing. Part A and Part B were mixed by hand for 30 seconds prior to its casting into a mold to form its desire shape. The porous silicone monolith fully cured after 1 hour. The resulting composition was calculated to contain approximately 5 to 30 ppm of elemental platinum

### Example 2d. Mixture using Commercial Porous Foam

70 g of Silbione RT foam 4230A was mixed with 30 g of ElKem Silbione RTV4410A using a high speed centrifugal mixer (FlackTek DAC150 FV-K) at 3470 rpm for 1 min to form the Part A mixture.

70 g of Silbione RT foam 4230B was mixed with 30 g of ElKem Silbione RTV4410B using a high speed centrifugal mixer (FlackTek DAC150 FV-K) at 3470 rpm for 1 min to form the Part B mixture.

Both the Part A and Part B mixtures were separately stored at −25 C prior to their final mixing. Both the Part A and Part B mixtures were mixed by hand for 30 seconds prior to their casting into a mold to form its desire shape. The porous silicone monolith fully cured after 1 hour. The resulting composition was calculated to contain approximately 5 to 30 ppm of elemental platinum.

### Example 2e. Mixture using Commercial Porous Foam

90 g of Silbione RT foam 4230A was mixed with 10 g of ElKem Silbione RTV4410A using a high speed centrifugal mixer (FlackTek DAC150 FV-K) at 3470 rpm for 1 min to form the Part A mixture.

90 g of Silbione RT foam 4230B was mixed with 10 g of ElKem Silbione RTV4410B using a high speed centrifugal mixer (FlackTek DAC150 FV-K) at 3470 rpm for 1 min to form the Part B mixture.

Both the Part A and Part B mixtures were separately stored at −25 C prior to their final mixing. Both the Part A and Part B mixtures were mixed by hand for 30 seconds prior to their casting into a mold to form its desire shape. The porous silicone monolith fully cured after 1 hour. The resulting composition was calculated to contain approximately 5 to 30 ppm of elemental platinum.

### Example 3a, Preparation of Porous Silicone Encapsulant Film

Part A

90 g of Elkem 55 experimental base (containing vinyl terminated polydimethyl silicone base polymer and fume silica particles) was mixed with 1 g of the PT catalyst (as synthesized according Example 1-SF from co-pending , commonly assigned patent application, U.S. Ser. No. 17/327,940 (ETH6070USCIP1) the entire disclosure incorporated herein by reference with Example 1-SF reproduced below)* and 9 g of 0.5% Gelest SIP 6830.3 (3.0% platinum divinyl tetramethyldisiloxane complex in vinyl terminated polydimethylsiloxane, Karstedt catalyst—xylene solvent free) in low molecular weight vinyl terminated polydimethyl siloxane (Gelest DMS V21) using a high-speed centrifugal mixer (FlackTek DAC150 FV-K) at 3470 rpm for 3 minutes.

* Example 1-SF (U.S. Ser. No. 17/327,940; ETH6070USCIP1) : 2.7 g of diethyl maleate was mixed with 3.6 g of diethyl ether and 3.6 g of Gelest SIP 6830.3 (3.0% platinum divinyl tetramethyldisiloxane complex in vinyl terminated polydimethylsiloxane, Karstedt catalyst—xylene solvent free) at ambient temperature for 24 hours. 64.9 g of Gelest SIP 6830.3 was then added into the above mixture and mixed for an additional 72 hours while the lid of the container remained open. Finally, 928.8 g of vinyl terminated polydimethylsiloxane (Gelest DMS V21) was added and mixed for an additional 4 hours. The novel platinum catalyst master batch contains the novel catalyst having 2055 ppm of elemental platinum with essentially the remainder being vinyl terminated polydimethylsiloxane and wherein the catalyst comprises a platinum tetramethyldivinyl disiloxane diethyl maleate complex having the formula:

Pt[(CH₂═CH)(CH₃)₂Si]₂O.(COCH═CHCO)(C₂H₅O)₂

Part B

90 g of Elkem 55 experimental base (containing vinyl terminated polydimethyl silicone base polymer and fume silica particles) was mixed with 10 g of polymethylhydro-co-polydimethyl siloxane cross linker (Gelest HMS H301) using a high-speed centrifugal mixer (FlackTek DAC150 FV-K) at 3470 rpm for 3 minutes.

Both parts of example 3a were mixed using a conventional dual barrel syringe equipped with a static mixer and applied onto a Teflon film substrate. In order to obtain a film with uniform thickness, a conventional draw down bar was used for the coating process. The film fully cured in 1 minutes. A 20×20 mm coupon of the free-standing film was cut for density and porosity measurement. The resulting composition was calculated to contain approximately 17 ppm of elemental platinum.

### Example 3b, Preparation of Porous Silicone Encapsulant Film

Part A

90 g of Elkem 55 experimental base (containing vinyl terminated polydimethyl silicone base polymer and fume silica particles) was mixed with 1 g of the catalyst of Example 3a and 9 g of 0.5% Gelest SIP 6830.3 (3.0% platinum divinyl tetramethyldisiloxane complex in vinyl terminated polydimethylsiloxane, Karstedt catalyst—xylene solvent free) in low molecular weight vinyl terminated polydiemthyl siloxane (Gelest DMS V21) using a high-speed centrifugal mixer (FlackTek DAC150 FV-K) at 3470 rpm for 3 minutes.

Part B

90 g of Elkem 55 experimental base (containing vinyl terminated polydimethyl silicone base polymer and fume silica particles) was mixed with 10 g of polymethylhydro-co-polydimethyl siloxane cross linker (Gelest HMS H501) using a high-speed centrifugal mixer (FlackTek DAC150 FV-K) at 3470 rpm for 3 minutes.

Both parts of Example 3b were mixed using a conventional dual barrel syringe equipped with a static mixer and, applied onto a Teflon film substrate. In order to obtain a film with uniform thickness, a conventional draw down bar was used for the coating process. The film fully cured in 1 minute. A 20×20 mm coupon of the free-standing film was cut for density and porosity measurement. The resulting composition was calculated to contain approximately 17 ppm of elemental platinum.

### Example 4, Testing of Examples

Porosity measurement.

Porosity of the silicone foam is calculated according to the following formula:

1-D1/D2, D1 is the density of silicone foam and D2 is the theoretical density of solid silicone rubber, which assumed to be 1.1. Density, D1 of the samples were determined by casting the combined Part A and Part B mixture described in the examples, into a cylindrical mold with a 14 mm diameter and depth of 4 mm, The density was simply calculated by dividing the weight of the sample specimen by the volume of the sample specimen.

The formula for porosity can be simplified to the following:

Porosity (%)=(1.0−D1/1.1)×100%.

The testing results are summarized in Table 1.

TABLE 1

| | Density | Porosity | |
|---|---|---|---|
| Sample | (g/cm3) | (%) | Leakage |
| Example 1a | 1.08 | 1.9 | NO |
| Example 1 b | 1.03 | 6.0 | NO |
| Example 1c | 0.67 | 38.7 | NO |
| Example 2a | 0.73 | 33.3 | NO |
| Example 2 b | 0.59 | 46.8 | NO |
| Example 2c | 0.36 | 67.1 | NO |
| Example 2d | 0.28 | 74.8 | MINOR |
| Example 2e | 0.22 | 80.4 | YES |
| Example 3a | 1.08 | 1.8 | NO |
| Example 3b | 1.06 | 3.6 | NO |
| Control (Made with Elkem | 1.10 | 0 | NO |
| Silbione RTV4410) | | | |

Leakage Testing:

The leakage test was performed using a conventional dual barrel syringe. 4 mm thick porous silicone disks with the same dimension of the syringe caps were fabricated and used a the septa (feature (20) in FIG. 2) for the syringe cap (feature (10) in FIG. 2). Samples with 7 levels of porosity were made and installed into the syringe for leakage testing, as illustrated in FIG. 2 which shows the overall syringe assembly (1) comprising a cap (10), porous silicone seal (septa) (20), dual barrel syringe (30) and dual plungers (40).

A solvent-free silicone adhesive was loading into the syringe. The viscosity of the adhesive in the syringe barrels Part A and Part B was in the range of 25,000 to about 40,000 cps (measured at temperature 25° C.). The entire assembly was placed under vacuum for 2 hr under 30 mm Hg vacuum, the septa (feature (20) of FIG. 2, porous silicone seal made according to the methods of this invention) with the top two highest percentage porosity were not able to totally prevent the formula from leaking out of syringe during the vacuum test. (see Table 1, for results under the “Leakage” heading).

Encapsulation of Biological Indicators

Biological Indicators (BIs) are widely used to monitor the efficacy of sterilization processes. BIs provide a high level of sterility assurance and are ideal monitors of the sterilization process. The BI Sterility test is performed on exposed BIs after completion of a EO sterilization cycle. The test is qualitative which yields results of either growth or no growth of the appropriate indicator organism which indicates whether or that the biological indicator was adequately sterilized.

We have found that a coating over the BI is required to protect the BI from being damaged or inoperable when the BI is placed in silicone formulations without the protective coatings of this invention. The porous coatings or films of this inventions are porous enough to allow sterilant gas to pass and are sufficiently impermeable to prevent passage of a cross linkable silicone formulation through the coating which, if permitted to pass, would render the BI inoperable as giving false negative indications.

Specifically, the BI without coating was placed inside the contents of a syringe barrel containing a cross-linkable silicone Part A formulation with the intention of indicating that the entire batch of material being exposed to EO is sterilized. However, it was discovered that the paper package of the commercial BI was not able to withstand the penetration of the silicone formulation. The silicone formulation came to contact with the bacteria spores inside the BI and led to false negative readings. We found that encapsulation of the BI is required to ensure the integrity of the validation testing. The encapsulant which is the inventive porous silicone coating needs to have no impact on the bacteria spores inside the BI and its surrounding silicone material during the sterilization process.

In response to the above observed matter, porous fast cured silicone encapsulants were developed for this application. Representative of these encapsulants are the silicones developed in Examples 3a and 3b. The encapsulant can coat the surface of commercial paper containing BI readily and cured rapidly (within minutes) on the surface of the BI, no silicone formulation penetration was observed on the encapsulated BI after the sterilization process. Low levels of closed cell porosity is intentionally created in this encapsulant to ensure maximum permeation of EO gas through the encapsulant while blocking passage of the liquid silicone formulation contained in the barrel(s) of the syringe

In making the encapsulated BI, a two-part low porosity silicone sealant composition was mixed using a conventional dual barrel syringe equipped with a static mixer and applied onto the surface of biologic indicator. In order to cover the entire area of with 2 mm extra width on all side a conventional draw down bar was used for the coating process. The same process was repeated on the other side of the BI after 1 hour. The entire BI is encapsulated by the porous silicone sealant and is depicted in FIG. 4. Specifically feature (100) represents the BI strip containing bacterial spores, feature (200) represents the paper packaging around the BI strip and feature (300) represents the inventive, porous silicone coatings of this invention.

Spordex™ Biological Indicator was purchased from Steris which is small strip of special filter paper inoculated with Bacillus atrophaeus (BA) spores packaged in a glassine pouch. Spordex™ Biological Indicator is further encapsulated with porous silicone coating prepared according to the procedure described in example 3a. This silicone encapsulated BIs were placed inside the silicone adhesive in the middle of the barrel inside the syringe.

The BI containing syringes were subjected to EO sterilization. A separate set of BI containing syringes with the same configuration was kept aside and used as control samples and not exposed to EO. The EO exposed BI was then placed in the media suitable for bacterial growth, to verify presence or absence of bacterial growth, up to 7 days after the EO exposure. The absence of bacterial growth in the media indicated EO sterilization process was successful. The control BI sample (not exposed to EO) was also tested to verify normal bacterial growth during the same incubation period, i.e., to verify that the BI is working. With no bacterial growth found for the EO sterilized BI, the invention demonstrated that a biological indicator coated with the porous coatings of this invention is permeable and sterilizable by ethylene oxide gas and impermeable by a cross-linkable silicone liquid.

These porous coatings comprise the cured silicone composition described above which advantageously adhere well to the biological indicator glassine package.

In other embodiments, the porous coatings of this invention comprising the cured silicone compositions described above, advantageously adhere well to a range of substrates, including, paper packaging, metal, polyester films.

The compositions of this invention may contain one or more chemical materials located in or on it. For example, one or more chemical substances may be dispersed in the mixing components or on the cured compositions, such as being chemically bound, physically bound, absorbed, or adsorbed to it. Such chemical materials that may be present include, but are not limited to, any suitable and preferably compatible additive that enhances performance of the composite structure. Such additional chemical substances may be bioactive or non-bioactive. Suitable other chemical substances thus include, but are not limited to, colorants (such as inks, dyes and pigments), scents, protective coatings that do not chemically detach, temperature sensitive agents, drugs, wound-healing agents, anti-microbial agents and the like.

Although this invention has been shown and described with respect to detailed embodiments thereof, it will be understood by those skilled in the art that various changes in form and detail thereof may be made without departing from the spirit and scope of the claimed invention.

We claim:

1. A method of making a porous silicone composition comprising the steps of:
a) cooling a Part A composition comprising a mixture of:
60 to 95 wt. % vinyl terminated polydimethylsiloxane base polymer and fumed silica particles,
5 to 15 wt. % vinyl terminated polydimethylsiloxane having a molecular weight ranging from 3,000 to 9,000, and
a platinum containing catalyst; and
b) cooling a Part B composition comprising a mixture of:
60 to 90 wt. % vinyl terminated polydimethylsiloxane base polymer and fumed silica particles, and
10 to 40 wt. % polymethylhydro-co-polydimethyl siloxane cross linker; and
c) mixing the Part A and Part B compositions to form a combined composition and permitting the combined composition to form a cured porous silicone composition;
wherein the platinum containing catalyst comprises at least 1 ppm of elemental platinum in said combined composition.

2. The method of claim 1, wherein
Part A comprises 30-100 wt. % vinyl terminated polydimethylsiloxane base polymer and fumed silica particles,
5 to 15 wt. % vinyl terminated polydimethylsiloxane having a molecular weight ranging from 3,000 to 9,000, and a platinum-containing catalyst; and
Part B comprises 0 to 30 wt. % vinyl terminated polydimethyl silicone base polymer and fumed silica particles, and
10 to 40 wt. % polymethylhydro-co-polydimethyl siloxane cross linker.

3. The method of claim 1, wherein
Part A comprises 0 to 40 wt. % vinyl terminated polydimethylsiloxane base polymer and fumed silica particles,
5 to 15 wt. % vinyl terminated polydimethylsiloxane having a molecular weight ranging from 3,000 to 9,000, and
a platinum-containing catalyst; and
Part B comprises 70-100 wt. % vinyl terminated polydimethylsiloxane base polymer and fumed silica particles, and
10 to 40 wt. % polymethylhydro-co-polydimethyl siloxane cross linker.

4. The method of claims 1-3 wherein the Part A and Part B compositions are cooled below (+5 C) prior to mixing.

5. The method of claims 1-3 wherein the Part A and Part B compositions are cooled in the range of −20 to −60 C prior to mixing.

6. The method of claims 1-3, wherein the Part A and Part B compositions are cooled to—25 C prior to mixing.

7. The methods of any one of clams 1-3, wherein the elemental Pt is in the range of 1-150 ppm.

8. The method of claim 7, wherein the elemental Pt is in the range of 5-30 ppm.

9. A composition produced by any one of the methods of clams 1-3.

10. A composition produced by any one of the methods of claim 4.

11. A composition produced by any one of the methods of claim 5.

12. A composition produced by any one of the methods of claim 6.

13. A composition produced by any one of the methods of claim 7.

14. A composition produced by any one of the methods of claim 8.

15. A porous coating formed by curing a liquid composition comprising:
a cross-linkable silicone polymer having reactive functionalities;
a silica-containing composition;
a silicone cross-linking agent; and
a catalyst, wherein said catalyst comprises at least two catalysts,
a first catalyst comprising a Karstedt's catalyst comprising Platinum-divinyl-tetramethyldisiloxane complex, and
a second catalyst comprising platinum tetramethyldivinyl disiloxane diethyl maleate complex having the formula:
Pt[(CH₂═CH)(CH₃)₂Si]₂O.(COCH═CHCO)(C₂H₅O)₂ (i)
or
Pt[(CH₂═CH)(CH₃)₂Si]₂O (ii)
or mixtures thereof of catalysts (i) and (ii), wherein the platinum containing catalyst comprises at least 1 ppm of elemental platinum in the composition.

16. The porous coating of claim 15, wherein the elemental Pt is in the range of 1-150 ppm.

17. The porous coating of claim 16, wherein the elemental Pt is in the range of 5-30 ppm.

18. The porous coating of claim 15, wherein said porous coating is permeable by ethylene oxide gas and impermeable by a cross-linkable silicone liquid.

19. The porous coating of claim 15, wherein said porous coating is applied to biological indicator.

20. A biological indicator coated with the composition of claim 15.
